(19) United States
(12) Patent Application Publication
(10) Pub. No.: US 2013/0138705 A1
(43) Pub. Date: May 30, 2013

(54) STORAGE SYSTEM CONTROLLER, STORAGE SYSTEM, AND ACCESS CONTROL METHOD

(71) Applicants: Masakuni Agetsuma, Tokyo (JP); Takaki Nakamura, Ebina (JP); Atsushi Sutoh, Yokohama (JP)

(72) Inventors: Masakuni Agetsuma, Tokyo (JP); Takaki Nakamura, Ebina (JP); Atsushi Sutoh, Yokohama (JP)

(73) Assignee: HITACHI, LTD.

(21) Appl. No.: 13/377,060

(22) PCT Filed: Nov. 28, 2011
(86) PCT No.: PCT/JP2011/006611

§ 371 Date: Dec. 8, 2011

(51) Int. Cl. G06F 17/30

(52) U.S. Cl. 707/822; 707/E17.01

(57) ABSTRACT

A control unit of a storage system controller receives an access command to a first file specifying a first access position in the first file. A storage apparatus stores management information of the first file and management information of each of subfiles obtained by dividing the first file. The management information of the first file contains information associating a data position in the first file and management information of a subfile containning data at the data position. The management information of each of the subfiles contains information associating a data position in the corresponding subfile and a physical storage position. The control unit references the management information of the first file to identify the management information of the subfile containning the data at the first access position, and references the management information of the identified subfile to identify a physical storage position of the first access position.

### TECHNICAL FIELD

This invention relates to a storage system controller, a storage system, and an access control method for a storage system.

### BACKGROUND ART

When a single file having a large size (hereinafter, referred to as large-size file) such as a disk image file, which is a file formed by virtualizing a disk device, a virtual machine disk (VMDK) file of a virtual disk used by a virtual machine, or a database file, and a file-based backup application program are used in combination, a change in only a part of the large-size file leads to backup of the entire file, which increases backup time.

A related file management technology which is known to date is a technique called Sparsebundle disk image (see, for example, Non Patent Literature 1). In this technique, a single disk image file is converted to a disk image including a plurality of small-size files (hereinafter, referred to as subfiles) (hereinafter, referred to as subfile conversion), and updates are managed on a subfile basis to restrict the subfiles to be backed up, to thereby reduce the backup time.

### CITATION LIST

### Non Patent Literature

NPL 1: Apple Inc., hdiutil(1) Mac OS X Manual version 10.6.6, BSD General Commands Manual

### SUMMARY OF INVENTION

### Technical Problem

In the above-mentioned related technique, the original disk image file is divided into a plurality of regions, and the regions are copied to separate files, to thereby convert the original disk image file to subfiles. Therefore, copies of data blocks of the file are generated, and hence the subfile conversion processing takes time.

Further, the above-mentioned related technique is directed only to a special file format called “disk image file”. Therefore, in a case where the subfile conversion is applied to a VMDK file or a database file, the disk image file needs to be formatted to some file system once so that the VMDK file, the database file, or the like is stored therein. Therefore, a change in file path name or the like occurs, and hence operational flexibility is low.

### Solution to Problem

An aspect of the invention is a storage system controller for controlling a storage system storing data of files, comprising a control unit and a storage apparatus. The control unit receives an access command to a first file, which specifies a first access position in the first file. The storage apparatus stores management information of the first file and management information of each of a plurality of subfiles obtained by dividing the first file. The management information of the first file contains information associating a data position in the first file and management information of a subfile which contains data at the data position. The management information of each of the plurality of subfiles contains information associating a data position in a corresponding subfile thereof and a physical storage position. The control unit references the management information of the first file to identify the management information of the subfile which contains the data at the first access position. The control unit references the management infatuation of the identified subfile to identify a physical storage position of the first access position.

### Advantageous Effects of Invention

According to this invention, access to a file may be efficiently controlled.

### BRIEF DESCRIPTION OF DRAWINGS

FIG. 1 is a block diagram illustrating a configuration example of a computer system according to an embodiment of this invention.

FIG. 2 is a block diagram illustrating a hardware configuration of a unified storage system according to the embodiment of this invention.

FIG. 3 is a block diagram illustrating a hardware configuration of a management computer according to the embodiment of this invention.

FIG. 4 is a schematic diagram illustrating an overview of the embodiment of this invention.

FIG. 5 is a software configuration of a storage head according to the embodiment of this invention.

FIG. 6 is an example of file system management information according to the embodiment of this invention.

FIG. 7A is an example of extent information before subfile conversion according to the embodiment of this invention.

FIG. 7B is an example of extent information after the subfile conversion according to the embodiment of this invention.

FIG. 8 is an example of a subfile conversion policy management table according to the embodiment of this invention.

FIG. 9 is a flow chart of subfile conversion processing according to the embodiment of this invention.

FIG. 10 is a flow chart of I/O processing with respect to a file according to the embodiment of this invention.

FIG. 11 is an example of a graphical user interface (GUI) for managing subfile conversion policies according to the embodiment of this invention.

### DESCRIPTION OF EMBODIMENTS

Hereinafter, an embodiment of this invention is described with reference to the accompanying drawings. For clarity of explanation, the following descriptions and the accompanying drawings contain omissions and simplifications as appropriate. This invention is not limited to the embodiments, and such application examples as may fall within the idea of this invention are all encompassed in the technical scope of this invention. Unless otherwise specified, one or more of each component may be provided.

In the following description, various types of information are sometimes described with the expression “xxx table”, for example, but the various types of information may be expressed in a data structure other than the table. In order to show that the various types of information are not dependent on the data structure, the “xxx table” is sometimes referred to as “xxx information”.

A management system may be constituted of one or more computers. For example, when a management computer processes and displays information, the management computer constitutes the management system. When a plurality of computers are used to realize functions equivalent to the management computer, for example, the plurality of computers (which may include a computer for display when the display is performed by the computer for display) constitute the management system. In this embodiment, the management computer constitutes the management system.

In the following description, processing is sometimes described with a “program” as a subject. The program is executed by a processor (such as central processing unit (CPU)) to perform predetermined processing using a storage resource (such as memory) and/or a communication interface device (such as communication port) as appropriate, and hence the subject of the processing may be the processor. The processor operates as functional parts for realizing predetermined functions by performing operations in accordance with the programs. The apparatus and the system including the processor are an apparatus and a system including the functional parts.

The processing described with the program or processor as a subject may be described with a computer (such as unified storage system, management computer, client, or host) as a subject. The processor may include a hardware circuit for performing a part or entirety of the processing performed by the processor. A computer program may be installed to each computer from a program source. The program source may be, for example, a program distribution server (such as management computer) or a storage medium.

In this embodiment, a file system performs subfile conversion processing of a file. The subfile conversion processing of the file generates from a file to be subjected to the subfile conversion (called a parent file) a plurality of subfiles by dividing the parent file. The file system generates, in the subfile conversion processing, subfile management information based on management information of data blocks of the parent file. Block data of the parent file is allocated to each subfile. In this manner, the subfiles may be generated without copying the data blocks allocated to the parent file.

The file system in this embodiment receives an I/O with respect to the parent file and changes the I/O to an I/O with respect to a subfile. The file system provides an access interface to the parent file or the subfile depending on details of processing of an application program. In this embodiment, the subfile is a type of file, and the subfile can be further converted to subfiles.

This embodiment enables backup of a single file having a large capacity (large-size file) such as a disk image file, a virtual machine disk (VMDK) file, or a database file on an updated subfile basis. This eliminates the need to back up the entire large-size file when only a part of the large-size file is changed, which reduces the backup time.

This embodiment is applicable not only to backup but also to application programs that manipulate general files. For example, this embodiment enables data deduplication, hierarchical management processing, encryption processing, and compression processing to be performed on a subfile basis. This embodiment is widely applicable to a file storage system such as a file server or a NAS.

This embodiment eliminates the need to copy data blocks in the subfile conversion processing, and hence the subfile conversion processing may be performed in a short period of time. The subfile conversion processing by the file system may convert all general files including the disk image file, the VMDK file, and the database file to subfiles. The files may be converted to subfiles without being migrated to another file system, and hence it is not necessary to change the file path before and after the subfile conversion.

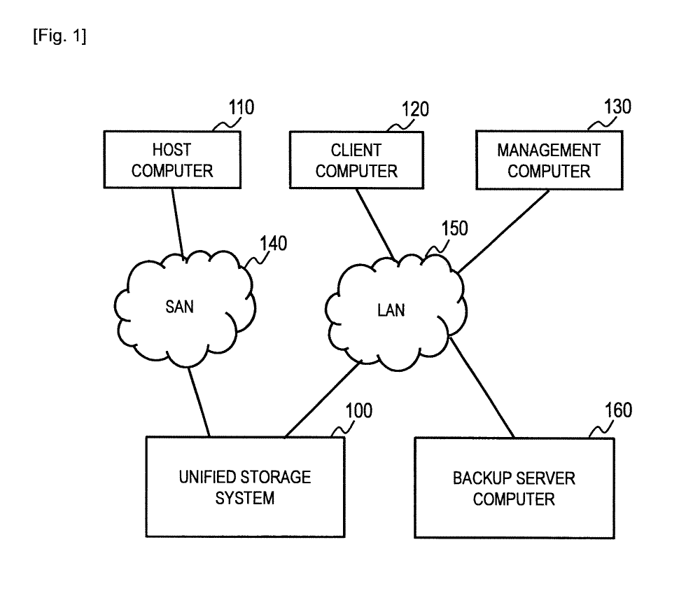

FIG. 1 is a block diagram illustrating a configuration example of a computer system according to this embodiment. The computer system includes a unified storage system 100, a host computer 110, a client computer 120, a management computer 130, a storage area network (SAN) 140, a local area network (LAN) 150, and a backup server computer 160.

The unified storage system 100 is coupled to a plurality of the host computers (or one host computer) (hereinafter, referred to as “host”) 110 via the SAN 140. The unified storage system 100 is also coupled to a plurality of the client computers (or one client computer) (hereinafter, referred to as “client”) 120, a plurality of the management computers (or one management computer) 130, and a plurality of the backup server computers (or one backup server computer) (hereinafter, referred to as “backup server”) 160 via the LAN 150.

The unified storage system 100 is a storage system capable of handling a plurality of data communication protocols. For example, the unified storage system 100 uses communication protocols that provide block volumes, such as Fibre Channel (FC), internet Small Computer System Interface (iSCSI), and Fibre Channel over Ethernet (FCoE), to perform data communication to/from the host 110 and the client 120.

Alternatively, the unified storage system 100 uses communication protocols that provide file sharing services, such as Network File System (NFS), Common Internet File System (CIFS), File Transfer Protocol (FTP), and Hyper Text Transfer Protocol (HTTP), to perform data communication to/from the host 110 and the client 120.

The unified storage system 100 receives an I/O request from, for example, the host 110 to a block volume via the SAN 140, and returns the processing result to the host 110. The unified storage system 100 receives an I/O request from the client 120 to a file sharing service via the LAN 150, and returns the processing result to the client 120. The unified storage system 100 receives an instruction from the management computer 130 and changes settings of the unified storage system 100.

The unified storage system 100 backs up data stored in the unified storage system 100 to the backup server 160 via the LAN 150. The unified storage system 100 performs the backup, for example, when instructed by the management computer 130 or regularly.

The unified storage system 100 may be coupled to a plurality of the SANs 140 and a plurality of the LANs 150. Further, the client 120, the management computer 130, and the backup server 160 may be coupled to the unified storage system 100 via different LANs 150, respectively. Alternatively, the unified storage system 100 may be coupled to the management computer 130 and the backup server 160 via a SAN. Further, the SAN 140 and the LAN 150 may be other types of communication networks such as a wide area network (WAN) or the Internet.

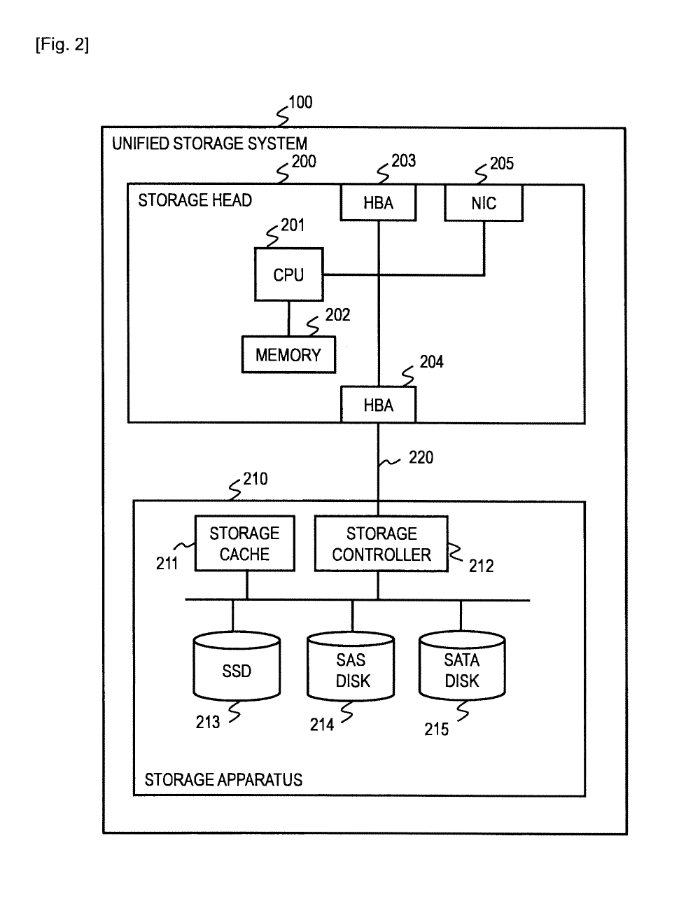

FIG. 2 is a block diagram illustrating a hardware configuration example of the unified storage system 100. The unified storage system 100 includes a storage head 200 and a storage apparatus 210. The storage head 200 and the storage apparatus 210 are coupled via a communication path 220.

The storage head 200 manages and controls the unified storage system 100 and the storage apparatus 210. The storage head 200 includes a memory 202, host bus adaptors (HBAs) 203 and 204, a network interface card (NIC) 205, and a CPU 201, which is a controlling unit coupled to the memory 202, the HBAs 203 and 204, and the NIC 205.

Instead of or in addition to the memory 202, a different kind of memory resource may be adopted. Instead of the HBAs 203 and 204 and the NIC 205, different kinds of communication interface devices may be adopted. The HBA 203 is coupled to the SAN 140. The HBA 204 is coupled to the storage apparatus 210 via the communication path 220. The NIC 205 is coupled to the LAN 150.

The CPU 201 executes computer programs stored in the memory 202. The memory 202 stores the computer programs and other data. The memory 202 may also include a cache region for temporarily storing data received from the host 110 and data to be transmitted to the host 110. The memory 202 may include a cache region for temporarily storing a file received from the client 120 and a file to be transmitted to the client 120.

The storage apparatus 210 is a storage apparatus for storing programs and files used by the storage head 200. The storage apparatus 210 includes a storage cache 211, a storage controller 212, a solid state disk (SSD) 213, a Serial Attached SCSI (SAS) disk 214, and a Serial ATA (SATA) disk 215. The respective components are coupled via an internal bus or an internal network.

The number of each of the storage caches 211, the storage controllers 212, the SSDs 213, the SAS disks 214, and the SATA disks 215 is not limited to that illustrated in FIG. 2. Also, the number of the storage apparatus 210 is not limited to that illustrated in FIG. 2. Hereinafter, the SSD 213, the SAS disk 214, and the SATA disk 215 are collectively referred to as disk apparatuses.

The storage controller 212 communicates with the storage head 200 to control the storage apparatus 210. Specifically, the storage controller 212 communicates with the storage head 200 to write data to the disk apparatus using the storage cache 211 to be described later in response to a request from the storage head 200, or to read data from the disk apparatus using the storage cache 211.

As described above, in this example, an access request received by, or data to be transmitted by, the storage controller 212 is block data (sometimes also simply referred to as blocks) specified in a block address format.

The storage cache 211 is, for example, a semiconductor memory, and is used to temporarily store the data to be written to the disk apparatus or the block data read from the disk apparatus. It should be noted that, as a part of the storage cache 211, a storage apparatus that is lower in speed than the semiconductor memory may be used.

The disk apparatus is an apparatus for storing data. In FIG. 2, the storage apparatus 210 includes one SSD 213, one SAS disk 214, and one SATA disk 215, but any number of the disk apparatuses may be installed in the storage apparatus 210. It should be noted that the disk apparatuses are typically the SSD 213, the SAS disk 214, and the SATA disk 215. However, the disk apparatus may be any apparatus as long as block format data may be stored therein, and may be an apparatus which uses, for example, a DVD, a CD, or a magnetic tape as a storage medium.

It should be noted that, for the reasons of increasing speed, redundancy, reliability, and the like, the storage controller 212 may provide a plurality of disk apparatuses as at least one accessible virtual disk apparatus to the storage head 200 (more specifically, RAID technology is used).

In the following description, the virtual disk apparatus is referred to as “volume”, and the description that “the storage apparatus or the storage controller writes block data in a volume” actually means that the storage controller 212 writes block data in the storage cache 211 or the disk apparatus.

Similarly, when it is described that “the storage apparatus or the storage controller reads block data from a volume,” it actually means that the storage controller 212 reads block data from the storage cache 211 or the disk apparatus.

In general, when a request to write data to a volume is received from the storage head 200, the storage controller 212 temporarily writes data to the storage cache 211 having a high access speed, and then notifies the storage head 200 of completion of the writing.

Then, the storage controller 212 writes data stored in the storage cache 211 to the disk apparatus asynchronously with the write request from the storage head 200, to thereby increase the performance of the entire storage apparatus 210 even when the disk apparatus is lower in performance compared to the storage cache 211.

The communication path 220 between the HBA 204 of the storage head 200 and the storage controller 212 of the storage apparatus 210 may be coupled via a switch. A plurality of storage heads 200 and a plurality of storage apparatuses 210 may be provided. A configuration may be adopted in which a plurality of the storage heads 200 are coupled to one storage apparatus 210. The storage head 200 and a plurality of storage apparatuses 210 may constitute a SAN.

The communication path 220 between the HBA 204 and the storage apparatus 210 is constituted of, for example, a fibre channel (FC). Another type of network (such as Ethernet) may be adopted as long as the network can communicate as the communication path 220.

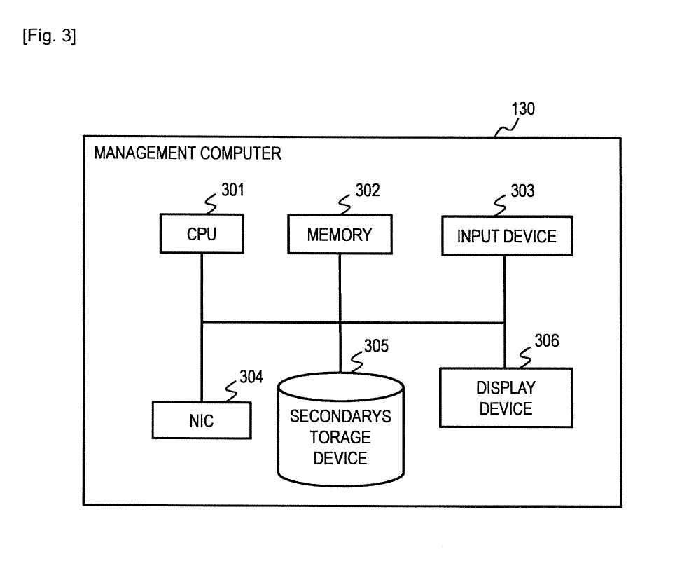

FIG. 3 is a block diagram illustrating a hardware configuration example of the management computer 130. The management computer 130 includes a memory 302, an input device 303, an NIC 304, a secondary storage device 305, a display device 306, and a CPU 301 coupled to the memory 302, the input device 303, the NIC 304, the secondary storage device 305, and the display device 306. Instead of at least one of the memory 302 and the secondary storage device 305, another type of storage resource may be adopted. Instead of the NIC 304, another type of communication interface device may be adopted.

A computer program is loaded from the secondary storage device 305 to the memory 302. The CPU 301 executes computer programs stored in the memory 302. The input device 303 is a device operated by an administrator, including, for example, a keyboard and a pointing device. The MC 304 is coupled to the LAN 150. The secondary storage device 305 is, for example, an HDD. The display device 306 is, for example, a liquid crystal display.

The management computer 130 may set, in accordance with operations from the administrator, information in the unified storage system 100. The information to be set in the unified storage system 100 includes, for example, a subfile conversion policy management table 550 to be described later.

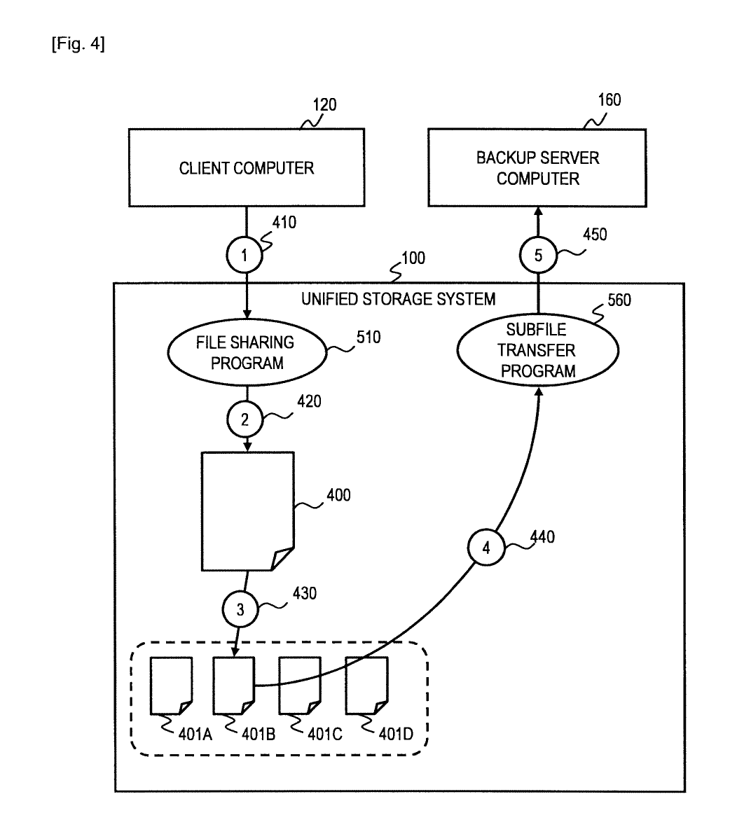

FIG. 4 is a schematic diagram illustrating an overview of this invention. FIG. 4 illustrates regular backup of a large-size file 400 shared by a file sharing program 510. In this case, the large-size file 400 is a 40 MB file and has been converted to four subfiles 401A, 401B, 401C, and 401D of 10 MB each.

The subfiles are stored in a predetermined directory in the file system in which the large-size file is stored. The file system is a function of managing and manipulating files and includes programs and information therefor. For example, in the following example, a virtual file system “/mnt/fs1” managed by the unified storage system 100 is mounted with the file system and stores a large-size file “linux-disk1.vmdk”.

Subfiles of “linux-disk1.vmdk” are stored under “/mnt/fs1/.subfiles/1230/”. In this case, “.subfiles” is a directory indicating a location in the file system for storing the subfiles, and “1230” is a directory named after an inode number of the large-size file. Names of the four subfiles express offsets generated by dividing the large-size file into units of 10 MB in hexadecimal.

Large-size file:

/mnt/fs1/linux-diks1.vmdk (400)

Subfiles:

/mnt/fs1/.subfiles/1230/0000000000000000 (401A)

/mnt/fs1/.subfiles/1230/0000000000A00000 (401B)

/mnt/fs1/.subfiles/1230/0000000001400000 (401C)

/mnt/fs1/.subfiles/1230/0000000001E00000 (401D)

The above-mentioned location for storing the subfiles is merely an example. For example, the location for storing subfiles may use a directory name other than “.subfiles”, a plurality of directories, or a plurality of directories across a plurality of file systems.

The directory name under “.subfiles” for classifying locations for storing subfiles for each large-size file may be, as a name other than the inode number, a universally unique identifier (UUID) or a file name of the large-size file. It should be noted, however, that when the file name of the large-size file is used, such processing as changing the directory name along with renaming of the large-size file is required, and hence it is generally desired to allocate a unique name such as the inode number or the UUID that will not be changed.

The subfile name does not need to be a name that expresses the offset of the large-size file in hexadecimal. The subfile name may be any name as long as it shows which area in the large-size file corresponds to which subfile, and may be, for example, a subfile name that expresses the offset in decimal. Not the offset but a serial number of the subfile in the large-size file may be used. Instead of above described directories with inode numbers under “.subfiles”, a keyword such as a large-size file name and the inode number of a large-size file may be added as a prefix or suffix of a subfile name to manage the corrensponcece between a large-size file and subfiles.

Next, referring to FIG. 4, a flow from the I/O with respect to the file 400 to the backup is described.

(1) If a write request 410 of 1 MB size is issued from the client 120 to a position of the large-size file 400 (/mnt/fs1/linux-disk1.vmdk) that is offset by 15 MB, the file sharing program 510 receives the write request (410).

(2) The file sharing program 510 performs, based on the write request from the client 120, write processing of 1 MB size to the position of the large-size file 400 that is offset by 15 MB. If the file has been converted to subfiles, the write processing is performed on the corresponding subfile as described below (420).

(3) A file I/O program 540 detects that the large-size file 400 has been converted to subfiles. The file I/O program 540 also determines that the write request of 1 MB size to the position that is offset by 15 MB is I/O processing with respect to a region assigned to the subfile 401B, and performs the write processing with respect to the subfile 401B (430).

(4) A subfile transfer program 560 regularly monitors the subfiles 401A to 401D of the large-size file 400 under “/mnt/fs1/.subfiles/1230/” for an update. The subfile transfer program 560 detects an update of the subfile 401B. The subfile transfer program 560 reads meta information (file name, size, access control information, and the like) of the large-size file 400 and data of the subfile 401B (440).

(5) The subfile transfer program 560 backs up the meta information of the large-size file 400 and the data of the subfile 401B as a set to the backup server 160 (450).

In the above-mentioned step (4), the subfile transfer program 560 detects an update by regularly monitoring the subfiles, but the method of detecting an update is not limited thereto. For example, when the file I/O program 540 updates a subfile, the file I/O program 540 may notify the subfile transfer program 560 that the subfile has been updated.

As described in the above-mentioned steps (1) to (5), even when the large-size file 400 is updated, instead of backing up the entire large-size file 400, only the meta information of the large-size file 400 and the subfile 401B are backed up, with the result that the backup time may be reduced.

Hereinafter, an example of a method of restoring the large-size file 400 that has been converted to four subfiles 401A to 401D for backup. In order to restore the large-size file 400, the unified storage system 100 downloads from the backup server 160 the meta information of the large-size file 400 and the subfiles 401A to 401D stored with the meta information of the large-size file 400 as a set.

The unified storage system 100 sequentially couples the subfiles 401A to 401D to form one file, and gives the meta information (file name and access control information) of the large-size file 400 to the coupled file. This completes the restoration of the large-size file 400 that has been converted into the subfiles. It should be noted that the restoration method is not limited thereto.

In the schematic diagram of FIG. 4, the subfile transfer program 560 transfers the subfile to the backup server 160 external to the unified storage system 100, but the subject application is not limited thereto. For example, the backup server 160 may be located within the unified storage system. The updated subfile may be transferred to the backup server 160 having a deduplication function, a compression function, an encryption function, and the like. The data of the subfile may be transferred to another storage system or to another file system within the unified storage system 100 to perform hierarchical management of the subfiles.

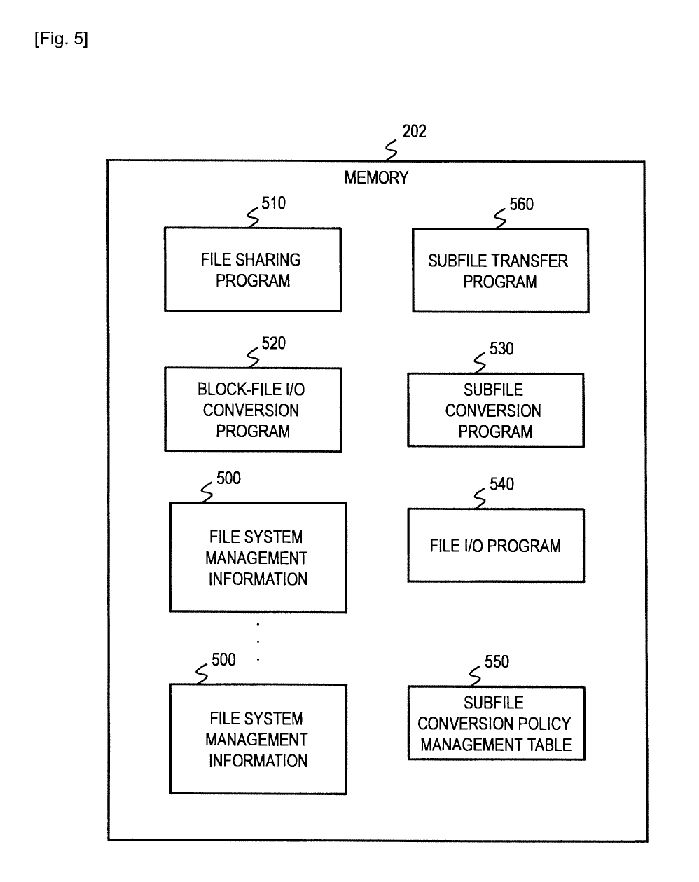

Hereinafter, this embodiment is described in detail. FIG. 5 is a software configuration example of the storage head 200. The software of the storage head 200 includes file system management information 500, the file sharing program 510, a block-file I/O conversion program 520, a subfile conversion program 530, the file I/O program 540, the subfile conversion policy management table 550, and the subfile transfer program 560. These are loaded and stored from a non-volatile storage apparatus to the memory 202.

The file system management information 500 includes information on the file system and information on files managed by the file system. Sets of the file system management information 500 correspond to file systems on a one-to-one basis. When the storage apparatus 210 provides a plurality of volumes, a set of the file system management information 500 is generated for each volume foarmatted as a file system and stored in the memory 202. Programs of FIG. 5 are common to the plurality of file systems. The file I/O program 540 and the subfile conversion program 530 are programs included in a file system. A piece of file system management information 500 is created for a file system.

The file sharing program 510 provides a file sharing service to the client 120 by using a communication protocol (NFS/CIFS/FTP/HTTP) and the like.

The block-file I/O conversion program 520 uses a communication protocol (FC/FCoE/iSCSI) and the like to provide a block volume to the host 110. Further, the block-file I/O conversion program 520 converts an I/O request with respect to the block volume, which is received from the host 110, to an I/O request with respect to a file.

The block-file I/O conversion program 520 provides a particular file managed by the unified storage system 100 to the host 110 as if the file were a block volume. Hereinafter, the file provided as the block volume is referred to as block volume file.

The subfile conversion program 530 performs processing for enabling a specified file to be accessed on a subfile basis. The file I/O program 540 processes I/Os with respect to files managed by the file system management information 500. The subfile conversion policy management table 550 includes information regarding policies for automatically determining a file to be subjected to the subfile conversion processing.

The subfile transfer program 560 detects an updated subfile from the file system management information 500 and backs up the updated subfile to the backup server 160. The method of detecting the updated subfile may include, for example, regularly checking time stamps 604 of all sets of inode information 600, which are managed by the file system management information 500 to be described later, for an update. Alternatively, for example, the file I/O program 540 may notify the subfile transfer program 560 of the updated subfile.

The subfile transfer program 560 is not limited to the cooperation with the backup server 160. For example, the storage apparatus 210 provides a volume A generated from the SSD 213, a volume B generated from the SAS disk 214, and a volume C generated from the SATA disk 215, and the storage head 200 manages the volumes as a file system A, a file system B, a file system C, respectively.

When an I/O load on a subfile stored in the file system B increases, the subfile transfer program 560 may migrate the subfile from the file system B to the faster file system A, to thereby realize the hierarchical management on a subfile basis.

Further, the subfile transfer program 560 may cooperate with a backup server having a deduplication function for backup data. The subfile transfer program 560 may also cooperate with a deduplication program, which operates in the storage head 200, and hence the subfile transfer program 560 itself may have a function of a backup server having the duplicate elimination function.

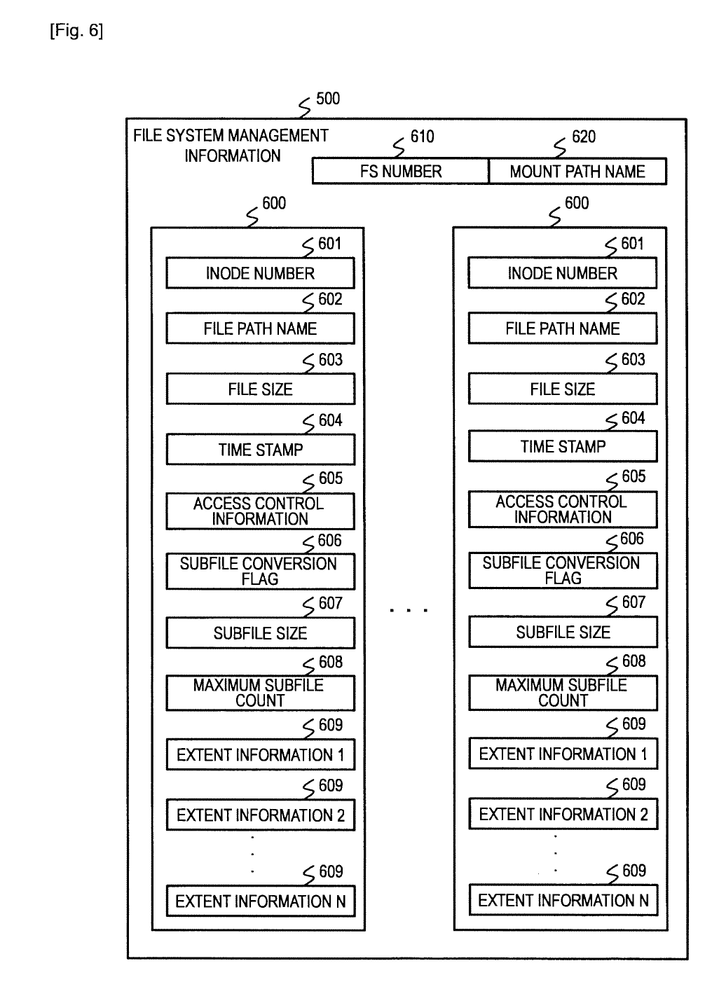

FIG. 6 is an example of the file system management information 500. The file system management information 500 includes at least one set of the inode information 600, an FS number 610, and a mount path name 620. The inode information 600 indicates a set of file management information generated for each file managed in the file system. The inode information 600 includes an inode number 601, a file path name 602, a file size 603, the time stamp 604, access control information 605, a subfile conversion flag 606, a subfile size 607, a maximum subfile count 608, and zero or more sets of extent information 609.

The inode number 601 indicates a unique number given to each file managed by the file system management information 500. The file path name 602 indicates a location of a file in the file system and a file name. The file size 603 indicates the size of the file. Depending on the file size 603, blocks of the volumes provided by the storage apparatus 210 are consumed.

The time stamp 604 indicates the time at which the file is updated. The file I/O program 540 overwrites, when an I/O with respect to the file is processed, the time stamp 604 with the time when the I/O is processed. The access control information 605 indicates access control information of the file. The access control information 605 is used when only particular users are allowed to access the file. The access control information 605 is sometimes also referred to as “permissions”, or as “access control list (ACL)” that enables higher level of access control than the permissions.

The subfile conversion flag 606 is information indicating whether or not the file has been converted to subfiles. The subfile size 607 indicates units for creating subfiles when the file has been converted to subfiles. The maximum subfile count 608 indicates the upper limit of the number of subfiles that can be created for the file.

The extent information 609 generally indicates a position of a block of a volume allocated to the file. In this embodiment, the extent information 609 includes, depending on whether or not the file has been converted to subfiles, one of two kinds of information 609A and 609B to be described later. Details thereof are described later.

The FS number 610 indicates a unique number for distinguishing a plurality of sets of file system management information 500 and file systems corresponding to the sets of file system management information 500 in the unified storage system 100. The mount path name 620 indicates a coupling path to a virtual file system formed by a plurality of file systems in the unified storage system 100. Examples of the mount path name 620 are “/mnt/fs1” and “/mnt/fs2”. Generally, the client 120 accesses a file by specifying a path (full path) on the virtual file system. The path is, for example, “/mntfis1/linux-disk1.vmdk”.

The file sharing program 510 may detect to which file system the I/O is directed by comparing the path to the file requested by the client 120 and the mount path name 620 in each set of the file system management information 500. The file sharing program 510 may also identify to which file in which file system the I/O is directed by comparing the path to the file requested by the client 120 and the file path name 602 in the inode information 600 held in the file system management information 500.

Similarly, the block-file I/O conversion program 520 may detect to which file system the I/O is directed by comparing the path to the block volume file provided to the host 110 and the mount path name 620 in each set of the file system management information 500. The block-file I/O conversion program 520 may also identify to which file in which file system the I/O is directed by comparing the path to the block volume file and the file path name 602 in the inode information 600 held in the file system management information 500.

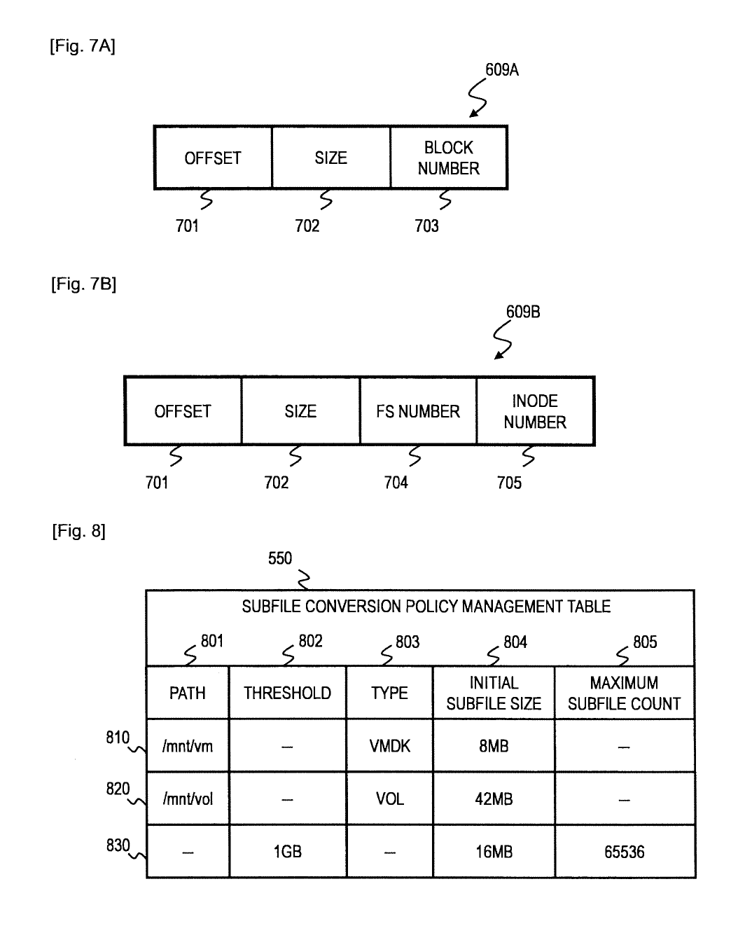

FIG. 7A is an example of extent information 609A before the subfile conversion. The extent information 609A includes an offset 701, a size 702, and a block number 703. The offset 701 indicates an offset value in the file managed by the extent information 609A. In other words, the offset 701 indicates a start position managed by the extent information 609A in the file.

The size 702 indicates the size of the region managed by the extent information 609A. The block number 703 indicates the block number in the block volume managed by the extent information 609A. In other words, the block number 703 indicates a start position managed by the extent information 609A in the block volume.

The extent information 609A associates a position of a region in the file and a position of the region in the volume provided by the storage apparatus 210 (physical storage position), and manages the correspondence therebetween. The region in the file, which is managed by the extent information 609A, is a region starting from the offset 701 of the file and having the size 702. Similarly, the region in the block volume, which is managed by the extent information 609A, is a region starting from the block number 703 and having the number of blocks corresponding to the size 702.

An I/O with respect to a file is generated with the offset and the size of the target file. Therefore, the position of the I/O target region in the file is determined from the offset and the size of the I/O, and at least one set of the extent information 609A for managing the I/O target region is selected from the inode information 600 for managing the file.

It is assumed, for example, that the inode information 600 of the I/O target file includes four sets of extent information 609A. In this example, the four sets of extent information 609A are denoted by EA0, EA1, EA2, and EA3 for convenience. In a case where the offset 701 of EA0 is 0 MB, the offset 701 of EA1 is 1 MB, the offset 701 of EA2 is 2 MB, and the offset 701 of EA3 is 3 MB so that EA0 to EA3 each have the size 702 of 1 MB, when the I/O has the offset of 1.5 MB and the size of 1 MB, two sets of extent information 609A, that is, EA1 and EA2, are selected.

Next, from at least one set of the selected extent information 609A, the size 702 and the block number 703 are retrieved to determine the position of the I/O target region in the volume (physical storage position).

It should be noted that sets of extent information 609A do not always need to be provided to cover the entire range of the file size. For example, although the file size is 10 MB, no extent information 609A may be provided. Such a file may be generally referred to as a “hole file” or a “sparse file”. With regard to such a file, at a time when an I/O to the file is generated and a block region is to be actually allocated to the file, the extent information 609A is created as necessary and the block region in the volume is allocated.

FIG. 7B illustrates an example of extent information 609B after the subfile conversion. The extent information 609B associates a position in the parent file and the subfile management information, and manages the correspondence therebetween. The extent information 609B includes the offset 701, the size 702, an FS number 704, and an inode number 705.

The offset 701 and the length 702 are the same information as in FIG. 7A. The FS number 704 is a number for identifying the file system management information 500 that manages the subfile managed by the extent information 609B. The mode number 705 is the mode number 601 for identifying the mode information 600 in the file system management information 500 identified by the FS number 704.

An I/O with respect to a file (parent file) that has been converted to subfiles is generated, similarly to an I/O with respect to a normal file, with the offset and the size of the I/O target file (parent file). Therefore, the storage head 200 can determine the position of the I/O target region in the parent file from the offset value and the size, and select at least one set of the extent information 609B for managing the I/O target region from the mode information 600 for managing the file.

Next, the storage head 200 retrieves the FS number 704 and the mode number 705 from each of the at least one set of the selected extent information 609B, and issues I/Os to the subfiles having the respective mode numbers 705.

The storage head 200 may create, similarly to the extent information 609A, the extent information 609B at the time of generation of an I/O as necessary. For example, when the extent information 609B corresponding to the offset and the size in the I/O target parent file does not exist, a subfile having the same size as the subfile size 607 included in the inode information 600 of the I/O target file is first created.

Further, the storage head 200 creates the extent information 609B by using the offset 701 in parent file and the size 702 of the subfile of the I/O target managed by the subfile, the FS number 704 of the file system that has created the subfile, and the inode number 705 of the subfile, and registers the created extent information 609B with the inode information 600 of the I/O target parent file. The phrase “to create a subfile” as used herein means to create the inode information 600 of the subfile in the file system management information 500.

Referring to FIG. 7B, there has been described the method of identifying a subfile by using the FS number 704 and the inode number 705. However, the method of identifying the subfile is not limited thereto. For example, there may be employed a method involving storing, instead of the FS number 704 and the inode number 705, a name of the subfile to which a unique name has been given in the system.

Alternatively, without the extent information 609B, sets of the offset 701, the size 702, the FS number 704 and the mode number 705 may be stored in a storage area managed by the extent information 609A of a parent file (a area storing file data and extended attribute), a file or file system management information 500 different from the parent file, or a data base (DB) such as a relational data base (RDB) and a key value store (KVS).

A subfile name unique in the system may be used with a storage area managed by the extent information 609A of a parent file, a file or file system management information 500 different from the parent file, or a DB.

Alternatively, the name of a subfile to be actually accessed may be determined from an offset of an I/O to a parent file by subfile names or path names of subfiles under some constraints, without storing the extent information 609A, 609B in the inode information 600 of the parent file.

For example, it may be determined that subfiles of a parent file “/mnt/fs1/linux-disk1.vmdk” are stored in paths under “/mnt/fs1/.subfiles/1230” with the inode number 601 “1230” of “linux-disk1.vmdk”.

If the file size of the parent file (linux-disk1.vmdk) is 40 MB and the subfile size is 10 MB, subfile names are determined to be 0000000000000000, 0000000000A00000, 0000000001400000, and 0000000001E00000, respectively, which are offsets of the parent file represented in hexadecimal.

If an I/O to the 15 MB (0xF00000 in hexadecimal) offset of the parent file (linux-disk1.vmdk) is issued, it is an I/O to an area in which the offsets are equals to or larger than 0xA00000 (in hexadecimal) and smaller than 0x1400000 (in hexadecimal). Thus, the I/O can be determined to be an I/O to the subfile “/mnt/fs1/.subfiles/1230/0000000000A00000”.

It should be noted, however, that in cases of the method of storing a subfile name unique in the system in the extent information 609B and the method of identifying the subfile name from the offset value, lookup processing to identify the inode information 600 of the subfile from the subfile name (searching for the file system management information 500 and the inode information 600) is required every time an I/O occurs.

FIG. 8 is an example of the subfile conversion policy management table 550. The subfile conversion policy management table 550 includes columns of path 801, threshold 802, type 803, initial subfile size 804, and maximum subfile count 805.

The path 801, the threshold 802, and the type 803 are included in conditions for the subfile conversion. The path 801 indicates a path to a file. Files stored under the path specified in the path 801 are subjected to the subfile conversion. The threshold 802 indicates a file size. Files having a size equal to or more than the file size specified in the threshold 802 are subjected to the subfile conversion.

The type 803 indicates the type of a file. Examples of the type 803 are a VMDK file (denoted by “VMDK” in FIG. 8) used for a virtual disk of a virtual machine, a database file, a block volume file (denoted by “VOL” in FIG. 8), and the like. Files of the type specified in the type 803 are subjected to the subfile conversion. Files satisfying the above-mentioned conditions at the same time are converted to subfiles.

The initial subfile size 804 and the maximum subfile count 805 are set when a file satisfying the above-mentioned conditions are converted to subfiles. The initial subfile size 804 indicates an initial size of the subfiles of the parent file. The maximum subfile count 805 indicates the limit of the number of the subfiles that can be included in the parent file. If it is highly likely that the maximum subfile count 805 will be exceeded, the size of the subfiles may be enlarged, to thereby suppress the number of subfiles.

The storage head 200 regularly checks the subfile conversion policy management table 550 and the file system management information 500 and converts a file that satisfies the conditions into subfiles. In the example of FIG. 8, the subfile conversion is performed when any one of conditions of policies 810, 820, and 830 shown in respective rows is satisfied. The policy 810 in the first row means that a VMDK file stored under the directory “/mnt/vm” is subjected to the subfile conversion, and that, at the time of the subfile conversion, the initial subfile size 804 is set to 8 MB.

The policy 820 in the second row means that a block volume file stored under the directory “/mnt/vol” is subjected to the subfile conversion, and that, at the time of the subfile conversion, the initial subfile size 804 is set to 42 MB. The policy 830 in the third row means that a file having a size equal to or more than 1 GB is subjected to the subfile conversion, and that, at the time of the subfile conversion, the initial subfile size 804 is set to 16 MB and the maximum subfile count 805 is set to 65,536.

It should be noted that the path 801, the threshold 802, and the type 803 in the subfile conversion conditions described in this embodiment are merely examples. Other examples of the subfile conversion conditions may include a file of a particular user, a file having particular access control information, and an access frequency of a file. The access frequency may be expressed as an I/O count per predetermined unit time (the number of read commands and/or write commands). For example, the storage head 200 may measure the I/O count per unit time with respect to the subfile and calculate the average value thereof for use in the determination of the conditions. The subfile conversion may require a plurality of conditions to be satisfied.

If the access frequency is included in the conditions for the subfile conversion, for example, the storage head 200 may determine the file size of the subfiles depending on the access frequency. The initial subfile size 804 of a file having high access frequency, for example, an access frequency higher than a predetermined threshold is set to be small, and the initial subfile size 804 of a file having low access frequency, for example, an access frequency equal to or lower than the predetermined threshold is set to be large. With this configuration, the number of sets of the inode information 600 may be suppressed while managing only frequently updated files with subfiles having fine granularity.

For example, the storage head 200 provides two different subfile sizes to allocate a small subfile size to subfiles of a file having an access frequency larger than the threshold and a large subfile size to subfiles of a file having an access frequency equal to or smaller than the threshold. The number of subfile sizes that can be selected depends on the design. The storage head 200 may use at least one threshold of the access frequency for determining the size of the subfiles.

As the number of sets of the inode information 600 becomes smaller, the number of sets of the inode information 600 in the file system management information 500 stored in a volume of the storage apparatus 210 becomes smaller accordingly, which leads to an increased capacity efficiency. Also if the number of sets of the inode information 600 that can be managed in the file system management information 500 has an upper limit, the number of sets of the inode information 600 may be made smaller.

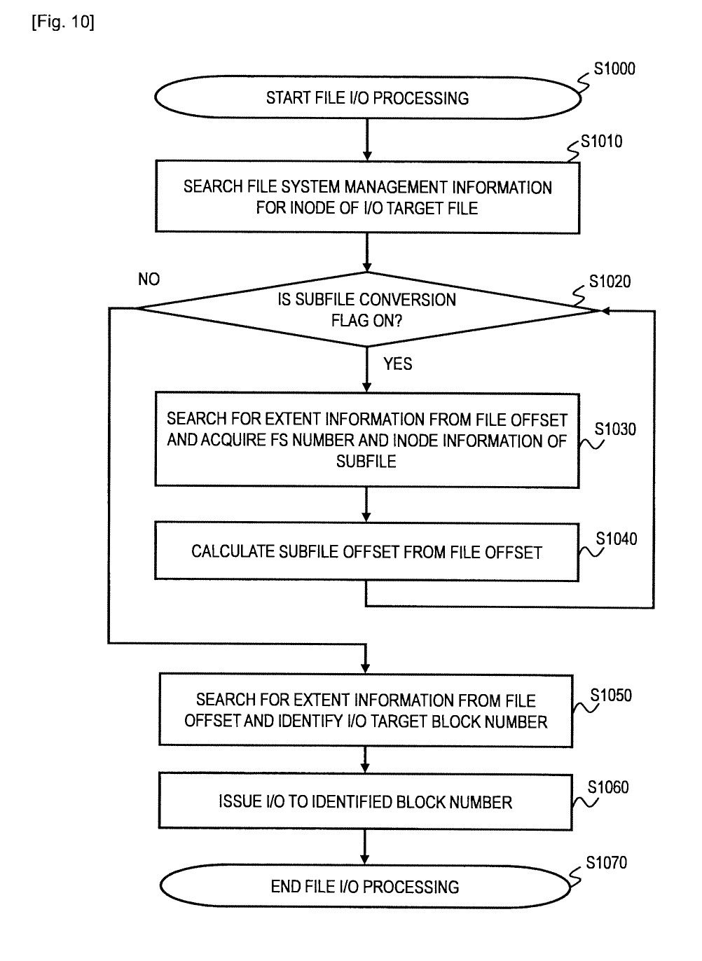

The subfile conversion policy management table 550 of FIG. 8 may be applied to subfiles. For example, the subfile conversion policy management table 550 may manage the access frequency. If the access frequency of a subfile is increased to be larger than a predetermined threshold, the storage head 200 may further convert the subfile to subfiles for management. Such subfile conversion of the subfile is referred to as division of the subfile. Dividing a subfile into smaller size subfiles allows management of updates of areas having high access frequency of the original parent file in finer granularity. For example, the update management in fine granularity allows reduction of the total size of subfiles subjected to backup. The subfile division processing is described later with reference to FIG. 10.

On the other hand, when the access frequency is decreased to be lower than a predetermined threshold (which is smaller than the above-mentioned threshold for the subfile conversion), the storage head 200 may cancel the subfile conversion, to thereby return the convered files to the original state. The cancellation of the subfile conversion is referred to as merging of the subfiles.

The merging of the subfiles includes, for example, erasing all sets of the extent information 609B of the parent subfile (subfile that has been converted to subfiles), copying all sets of the extent information 609A of the child subfiles (subfiles created from the parent subfile) to the parent subfile, and deleting the child subfiles. The phrase “to delete the child subfiles” means to erase the inode information 600 of the child subfiles from the file system management information 500.

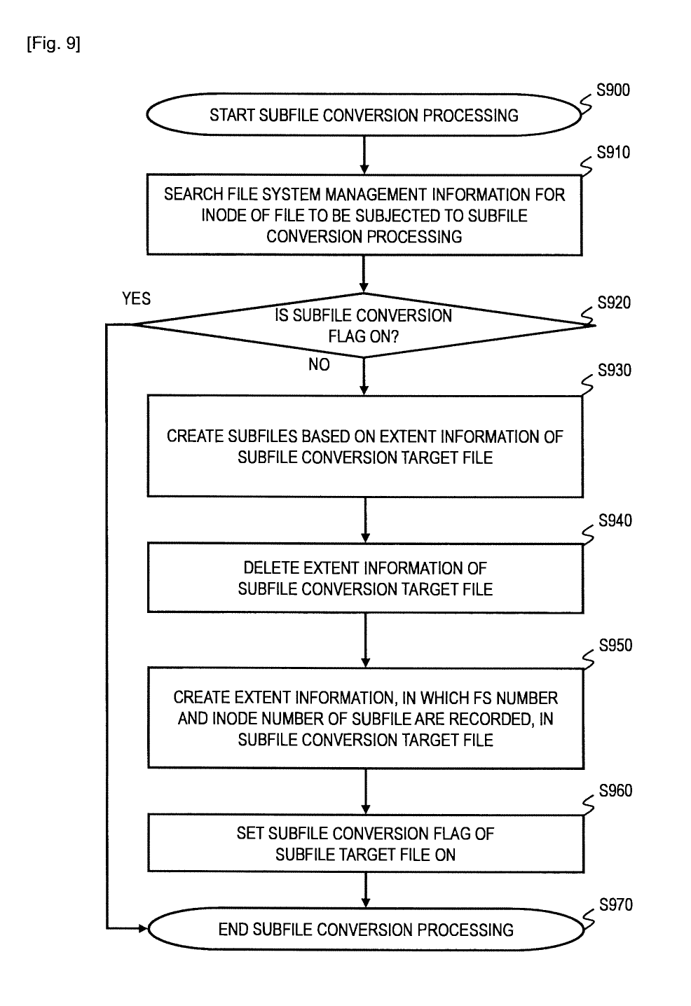

FIG. 9 is a flow chart of the subfile conversion processing. If the subfile conversion program 530 finds a file that satisfy the conditions of the subfile conversion policy management table 550 or receives a subfile conversion instruction directly from the administrator, the subfile conversion program 530 starts the subfile conversion processing with the path, the subfile size, and the maximum subfile count of the file to be processed (S900).

The subfile conversion program 530 searches the file system management information 500 for the inode information 600 of the file to be subjected to the subfile conversion processing (S910). The subfile conversion program 530 determines ON/OFF of the subfile conversion flag 606 from the inode information 600 (S920). If a result of the determination in Step S920 is positive (S920: YES), the subfile conversion program 530 ends the subfile conversion processing (S970).

If the result of the determination in Step S920 is negative (S920: NO), the subfile conversion program 530 creates, based on the extent information 609A of the file to be subjected to the subfile conversion processing, at least one subfile of the subfile size received in Step S900. The phrase “to create a subfile” as used herein means to create inode information 600 of the subfile including the extent information 609A of the subfile in the file system management information 500 (S930).

As an example, an inode number unique in the file system management information 500 is set at the mode number 601. “/mnt/fs1/.subfiles/<inode number 601 of the parent file>/<offset in the parent file corresponding to the subfile>” is set at the file path name 602. The subfile size 607 of the parent file is set at the file size 603.

The current time is set at the time stamp 604. The Access control information 605 of the parent file is set at the access control information 605. The subfile conversion flag 606 is set OFF. “0” is set at the subfile size 607. “0” is set at the maximum subfile count 608. The extent information 609A is created and set at the extent information 609. An example to create the extent information 609A will be described later.

In the above setting example of the inode number 601 of a subfile, the access control information 605 of the parent file is used for the access control information 605. The setting is not limited to this example. For example, the storage location of the access control information 605 of the parent file may be pointed and referenced.

Alternatively, access control information different from the access control information 605 of the parent file may be set. The reason why the subfile conversion flag 606 is OFF, “0” is set at the subfile size 607 and “0” is set at the maximum subfile count 608 is that the subfile is not different from a usual file which is not converted to subfiles. Thus, the subfile conversion program 530 can convert a subfile to subfiles (division of a subfile).

The subfile conversion program 530 deletes all sets of the extent information 609A from the inode information 600 of the file to be subjected to the subfile conversion processing (S940). The subfile conversion program 530 creates the extent information 609B corresponding to each subfile created in Step S930. Specifically, the subfile conversion program 530 creates, based on the information of the subfiles, the extent information 609B describing the offset 701, the size 702, and the FS number 704 and the inode number 705 of the subfile, and records the created extent information 609B in the inode information 600 of the file to be subjected to the subfile conversion processing (S950).

Steps S930 to S950 described above complete the processing of converting the extent information 609A of the file to be subjected to the subfile conversion processing to the extent information 609B and creating the subfiles.

It is assumed that, for example, the file to be subjected to the subfile conversion processing has four sets of the extent information 609A. The sets of the extent information 609A are expressed as EA0[0 MB, 0.5 MB, 0], EA1[0.5 MB, 1 MB, 2048], EA2[1.5 MB, 1 MB, 8192], and EA3[2.5 MB, 1.5 MB, 16384] for convenience, respectively.

In the brackets of EA1, the offset 701 of 0.5 MB, the size 702 of 1 MB, and the block number 703 of 2048 are described from the left. It is also assumed that the subfile size is 1 MB. In this case, four subfiles are created, and four sets of the extent information 609B respectively corresponding to the subfiles are created in the mode information 600 of the file to be subjected to the subfile conversion.

The four subfiles are all created in the file system having the same FS number 0 and are given inode numbers of 1000, 1001, 1002, and 1003, respectively. In this case, the extent information 609B can be expressed as EB0[0 MB, 1 MB, 0, 1000], EB1[1 MB, 1 MB, 0, 1001], EB2[2 MB, 1 MB, 0, 1002], and EB3[3 MB, 1 MB, 0, 1003]. In the brackets of EB1, the offset 701 of 1 MB, the size 702 of 1 MB, the FS number 704 of 0, and the inode number 705 of 1001 are described from the left.

EA4[0 MB, 0.5 MB, 0] and EA5[0.5 MB, 0.5 MB, 2048] are created in the inode information 600 of a subfile having an mode number “1000”. EA6[0 MB, 0.5 MB, 3072] and EA7[0.5 MB, 0.5 MB, 8192] are created in the inode information 600 of a subfile having an mode number “1001”. EA8[0 MB, 0.5 MB, 9216] and EA9[0.5 MB, 0.5 MB, 16384] are created in the inode information 600 of a subfile having an mode number “1002”. EA10[0 MB, 1 MB, 17408] is created in the inode information 600 of a subfile having an inode number “1003”. In this case, it is assumed that the volume is 512 bytes per block.

The subfile conversion program 530 sets the subfile size and the maximum subfile count received in Step S900 to the subfile size 607 and the maximum subfile count 608 of the inode information 600 of the file to be subjected to the subfile conversion processing, respectively, and sets the subfile conversion flag 606 ON (S960). The subfile conversion program 530 ends the processing (S970). Steps S900 to S970 described above achieve the subfile conversion by merely rewriting the extent information 609 without copying the block itself.

FIG. 10 is a flow chart of the I/O processing with respect to a file. If an I/O request with respect to a file is generated from the file sharing program 510 or the block-file I/O conversion program 520, the file I/O program 540 starts file I/O processing with the path to the I/O target file, the offset of the file, and an I/O size (S1000).

The file I/O program 540 searches the file system management information 500, with the path of the I/O target file as a key, for the mode information 600 of the I/O target file (S1010). The file I/O program 540 determines, from the mode information 600, whether the subfile conversion flag 606 is ON or OFF (S1020).

If a result of the determination in Step S1020 is positive (S1020: YES), the file I/O program 540 searches for the extent information 609B of the I/O target file by the offset and the size of the I/O target file. If the extent information 609B is not present, the file I/O program 540 creates a subfile, and the extent information 609B including the FS number 704 and the mode number 705 with which the subfile is created (S1030).

The file I/O program 540 identifies a subfile of the actual I/O target from the offset of the I/O target, and further subtracts the offset 701 of the extent information 609B from the offset of the I/O target file to calculate the offset of the identified subfile. Next, the file I/O program 540 searches for the inode information 600, using the FS number and the inode number of the subfile stored in the extent information 609B. Next, the file I/O program 540 retries the I/O processing from Step S1020 with the inode information 600 of the subfile, the offset of the subfile and the I/O size (S1040).

In other words, the file I/O program 540 retries the I/O processing by switching from the I/O target parent file to a subfile. Further, this processing repeats Steps S1020 to S1040 until a file that has not been converted to subfiles is found, and hence it is possible to handle a recursive case where the subfile has been further converted to subfiles.

If the result of the decision in Step S1020 is negative (S1020: NO), the file I/O program 540 identifies the extent information 609A from the offset of the I/O target file to identify the block number 703 as an I/O target (S1050). The file I/O program 540 issues an I/O with respect to the identified block number 703 (S1060). At the time of issuing the I/O, the time stamp 604 of the I/O target file is updated to the current time. The file I/O program 540 ends the processing (S1070).

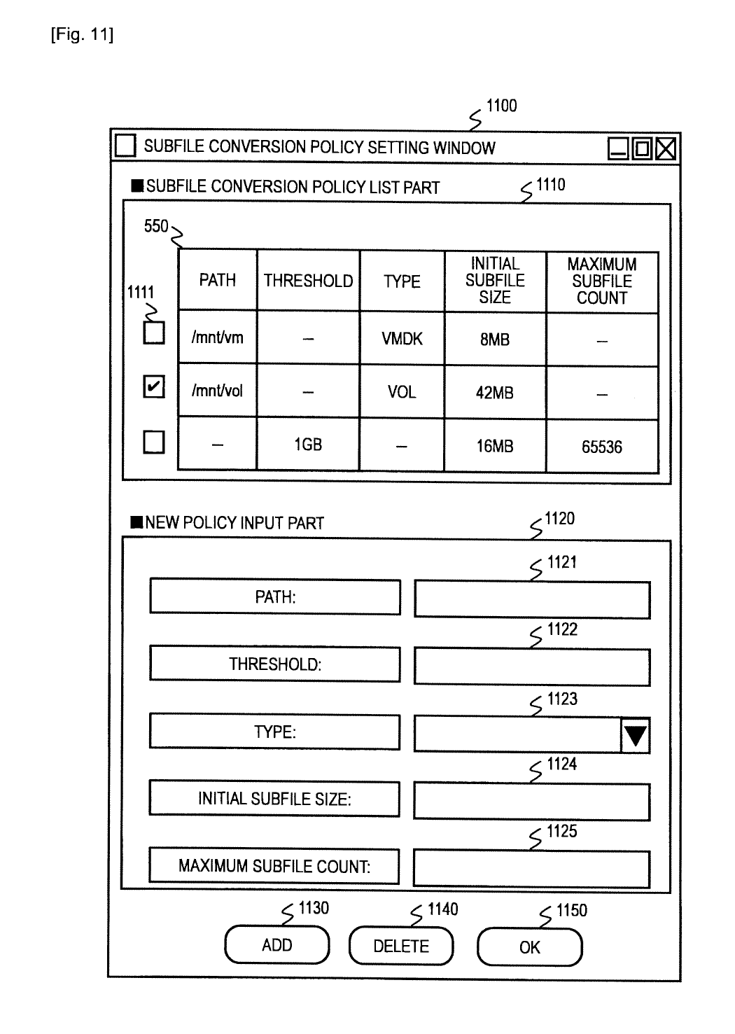

FIG. 11 illustrates a graphical user interface (GUI) 1100 for managing subfile conversion policies. The GUI 1100 includes a subfile conversion policy list part 1110, a new policy input part 1120, an “add” button 1130, a “delete” button 1140, and an “OK” button 1150.

The subfile conversion policy list part 1110 displays subfile conversion policies 550 set in the storage head 200. The new policy input part 1120 includes a field 1121 for inputting the path 801, a field 1122 for inputting the threshold 802, a field 1123 for inputting the type 803, a field 1124 for inputting the initial subfile size 804, and a field 1125 for inputting the maximum subfile count 805.

When the administrator presses the “add” button 1130, the management computer 130 instructs the unified storage system 100 to add the values input in the new policy input part 1120 as a new policy to a subfile conversion policy table 550. It should be noted that the new policy is added to the lowest row if any row is not specified by the check box 1111, and if a row is specified by a check box 1111, it is added to the row immediately below the row specified by the check box 1111.

When the administrator presses the “delete” button 1140, the management computer 130 instructs the unified storage system 100 to delete the subfile conversion policy in the row specified by the check boxes 1111 from the subfile conversion policy table 550. When the administrator presses the “OK” button 1150, the management computer 130 completes the setting of the subfile conversion policies and closes the GUI 1100.

Hereinabove, the embodiment of this invention has been described. However, the embodiment is merely illustrative of this invention, and is not intended to limit the scope of this invention to the above-mentioned configuration. This invention may be implemented in various other modes.

1. A storage system controller for controlling a storage system storing data of files, comprising:
a control unit; and
a storage apparatus,
the control unit receiving an access command to a first file, which specifies a first access position in the first file,
the storage apparatus storing management information of the first file and management information of each of a plurality of subfiles obtained by dividing the first file,
the management information of the first file containing information associating a data position in the first file and management information of a subfile which contains data at the data position,
the management information of each of the plurality of subfiles containing information associating a data position in a corresponding subfile thereof and a physical storage position,
the control unit referencing the management information of the first file to identify the management information of the subfile which contains the data at the first access position,
the control unit referencing the management information of the identified subfile to identify a physical storage position of the first access position.

2. The storage system controller according to claim 1,
wherein the control unit receives an access command to a first subfile of the plurality of subfiles, and
wherein the control unit references the management information of the first subfile to control access to the first subfile.

3. The storage system controller according to claim 1,
wherein the management information of the first file contains, before the plurality of subfiles are created, first information associating a data position in the first file and a physical storage position, and
wherein the control unit changes, in creating the plurality of subfiles from the first file, the association in the first information to association between the data position in the first file and management information of a subfile that contains the data at the data position.

4. The storage system controller according to claim 1,
wherein the control unit determines, when the first file satisfies a predetermined condition, to divide the first file, and
wherein the predetermined condition includes a condition on at least one of a path, a file size, a file type, and an access frequency of the first file.

5. The storage system controller according to claim 1,
wherein the management information of the first file contains subfile conversion information indicating whether or not the plurality of subfiles of the first file are present, and
wherein the control unit references the subfile conversion information to determine whether or not the first file has been divided into the plurality of subfiles.

6. The storage system controller according to claim 1, wherein the control unit creates, in a case where information associating a second access position in the first file specified by an access command and a subfile that contains data at the second access position is not present in the management information of the first file, information associating the second access position and the subfile that contains the data at the second access position, and management information of the subfile that contains the data at the second access position.

7. The storage system controller according to claim 1, wherein the first file is a subfile of a second file.

8. The storage system controller according to claim 1,
wherein the control unit monitors an access frequency of each of the plurality of subfiles, and
wherein the control unit determines, in a case where the access frequency of a first subfile of the plurality of subfiles exceeds a threshold, to divide the first subfile into a plurality of subfiles.

9. The storage system controller according to claim 1, wherein the control unit reflects the information associating a data position in each of the plurality of subfiles and a physical storage position in the management information of each of the plurality of subfiles to the management information of the first file and deleting the management information of each of the plurality of subfiles to merges the plurality of subfiles into the first file.

10. The storage system controller according to claim 1, wherein the control unit selects an updated subfile of the plurality of subfiles and transmits the updated subfile to a backup destination of the first file.

11. The storage system controller according to claim 1, wherein the information associating the data position in the first file and the management information of the subfile which contains data at the data position is a file name of the subfile.

12. A storage system, comprising:
a storage apparatus storing a plurality of files; and
a storage system controller for controlling access to the plurality of files,
the storage apparatus storing data of a first file,
the storage system controller receiving an access command to the first file, which specifies a first access position in the first file,
the storage system controller including management information of the first file and management information of each of a plurality of subfiles obtained by dividing the first file,
the management information of the first file containing information associating a data position in the first file and management information of a subfile that contains data at the data position,
the management information of each of the plurality of subfiles containing information associating a data position in a corresponding subfile thereof and a physical storage position,
the storage system controller referencing the management information of the first file to identify management information of a subfile that contains the data at the first access position,
the storage system controller referencing the management information of the identified subfile to identify a physical storage position of the first access position.

13. An access control method for a storage system storing a file that has been divided into a plurality of subfiles, comprising:
receiving an access command to a first file, which specifies a first access position in the first file;
referencing management information of the first file, which contains information associating a data position in the first file and management information of a subfile of the first file that contains data at the data position, to identify management information of a subfile that contains data at the first access position; and
referencing the management information of the identified subfile, which contains information associating a data position in the identified subfile and a physical storage position, to identify a physical storage position of the first access position.
